(19) United States
(12) Patent Application Publication
(10) Pub. No.: US 2006/0021386 A1
(43) Pub. Date: Feb. 2, 2006

(54) Forming device for forming optical glasses

(75) Inventor: Meng-Kun Wang, Taichung (TW)

Correspondence Address: MCNEES, WALLACE & NURICK LLC, 100 PINE STREET, P.O. BOX 1166, HARRISBURG, PA, 17108-1166, US

(73) Assignee: ASIA OPTICAL CO., INC., Taichung (TW)

(21) Appl. No.: 11/109,140

(22) Filed: Apr. 19, 2005

(30) Foreign Application Priority Data
Jul. 30, 2004 (TW) 093122915

(51) Int. Cl. C03B 9/40

(52) U.S. Cl. 65/323

(57) ABSTRACT

A forming device for forming a glass blank into a lens, includes lower and upper mold units, and a sleeve member removably mountable between the lower and upper mold units to hold the glass blank. The sleeve member has a sleeve wall defining a slot which includes a first slot section smaller in diameter than the glass blank, and a second slot section substantially equal in diameter to the glass blank. The sleeve wall has a first shoulder face formed between the first and second slot sections to support the glass blank, and a second shoulder face formed around the second slot section to support the lens. The second slot section serves to align the glass blank with the lower and upper mold units.

### CROSS-REFERENCE TO RELATED APPLICATION

This application claims priority from Taiwanese Invention Application No. 93122915 filed on Jul. 30, 2004.

### BACKGROUND OF THE INVENTION

1. Field of the Invention

This invention relates to a forming device, more particularly to a forming device for forming optical glasses.

2. Description of the Related Art

Referring to FIGS. 1 and 2, there is shown a conventional forming device for forming a glass blank into a lens. The forming device includes a sleeve member 1, a lower molding core 2 connected to the sleeve member 1 for placement of a glass blank 4, and an upper molding core 3 insertable into the sleeve member above the lower molding core 2. After the glass blank 4 is placed on the lower molding core 2, the upper molding core 3 is lowered to press and form the glass blank 4 into a lens 5 at high temperature. When the upper molding core 3 is removed from the sleeve member 1, a suction nozzle 7 is inserted into the sleeve member 1, as shown in FIG. 3, to suck and transfer the lens 5 to a next processing station. When the forming device is used in a continuous forming process, the sleeve member 1 together with the lower and upper molding cores 2, 3 are moved in order to carry and transport the glass blank 4 from station to station.

A problem encountered with such a forming device is that, during the process of placing the glass blank 4 onto the lower molding core 2, or during the process of transporting the forming device, the glass blank 4 is susceptible of misalignment with the central axis of the sleeve member 1, thereby resulting in positional deviation with respect to the lower and upper molding cores 2, 3, as shown in FIG. 4. The positional deviation will lead to formation of defective lenses with asymmetric thickness, as shown in FIG. 5.

### SUMMARY OF THE INVENTION

An object of the present invention is to provide an improved forming device which facilitates the centering of glass blanks with respect to the forming device.

Another object of the present invention is to provide an improved forming device with a sleeve member which can serve as a carrier for transferring a glass blank or lens between processing stations.

According to one aspect of the present invention, a forming device for forming a glass blank into a lens, comprises: at least one lower mold unit including a first forming face, and a first abutment face; at least one upper mold unit including a second forming face to confront the first forming face, and a second abutment face; and a sleeve member mountable detachably between the lower and upper mold units. The sleeve member has at least one sleeve wall defining a slot which includes a first slot section with a diameter smaller than an outer diameter of the glass blank, and a second slot section connected to the first slot section and having a diameter substantially equal to the outer diameter of the glass blank. The sleeve wall includes a third abutment face to abut against the first abutment face, a fourth abutment face to abut against the second abutment face, a first shoulder face formed between the first and second slot sections and adapted to support the glass blank, and a second shoulder fade formed around the second slot section above the first shoulder face and adapted to support the lens. When the sleeve member is assembled with the lower mold unit, the first abutment face abuts against the third abutment face, and the first forming face extends into the slot to a height higher than the second shoulder face.

According to another aspect of the present invention, a forming unit for forming a glass blank into a lens is provided, wherein each of the glass blank and the lens has a top face, and a bottom face which has a peripheral bottom end. The forming unit comprises a lower mold unit including a first forming face adapted to press the bottom face of the glass blank; an upper mold unit including a second forming face adapted to press the top face of the glass blank; and a sleeve member mountable between the lower and upper mold units and having a sleeve wall extending around the first and second forming faces. The sleeve wall has a support face provided around the first forming face and adapted to support solely the peripheral bottom end of the lens after the glass blank is formed into the lens.

According to further aspect of the present invention, a forming unit for forming a glass blank into a lens comprises: a lower mold unit including a first forming face; an upper mold unit including a second forming face; and a sleeve member mountable detachably between the lower and upper mold units and having a sleeve wall extending around the first and second forming faces. The sleeve wall has a first support face adapted to support the glass blank, and a second support face adapted to support the lens.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a sectional view of a conventional forming device;

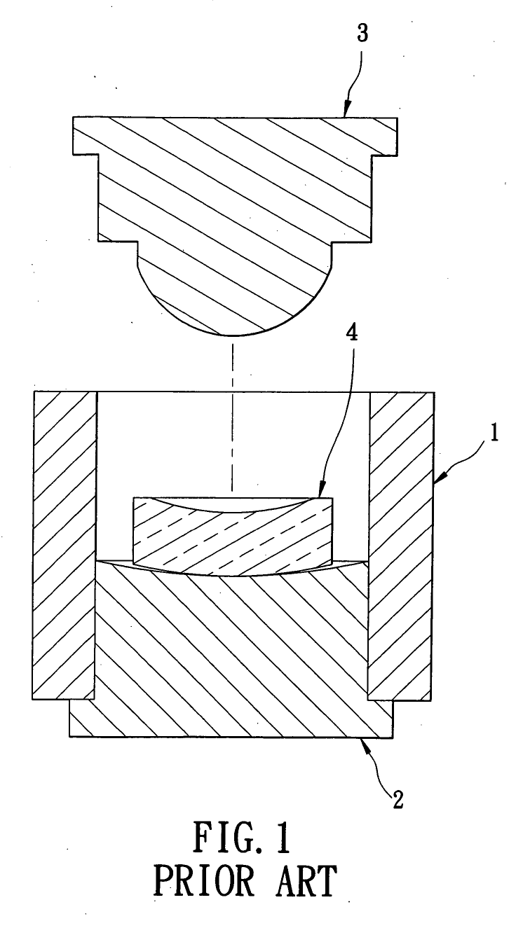

FIG. 2 is the same view as FIG. 1 but with an upper molding core being lowered;

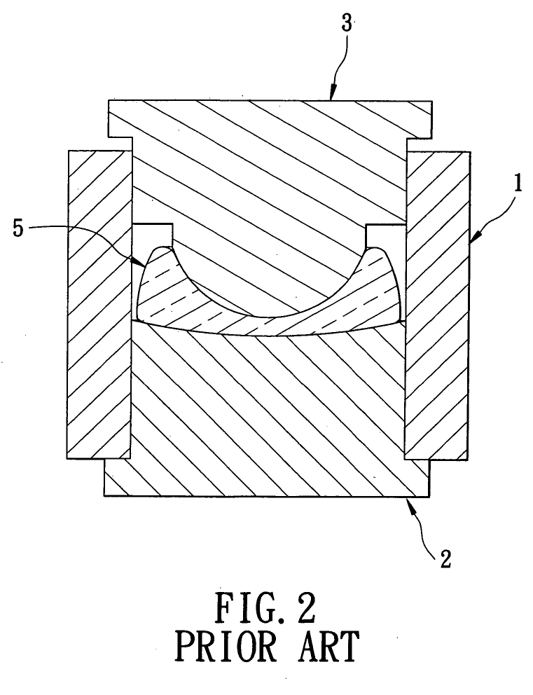

FIG. 3 is the same view as FIG. 1 but with the upper molding core being removed;

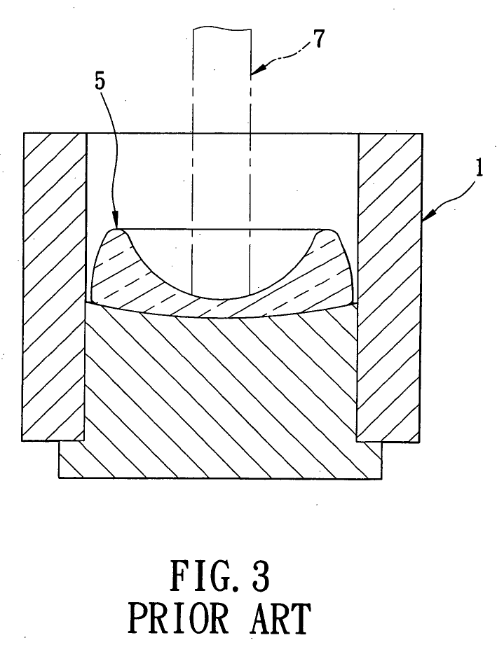

FIG. 4 is the same view as FIG. 1 but showing a misaligned glass blank;

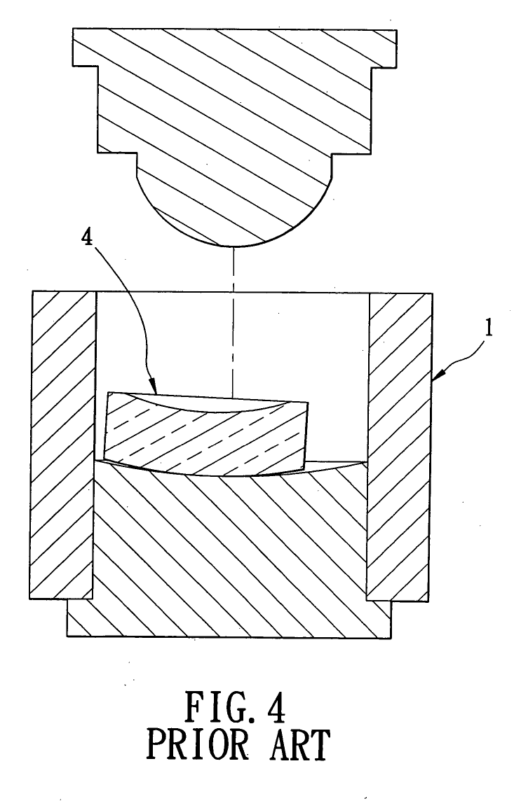

FIG. 5 is the same view as FIG. 1 but showing a deformed lens;

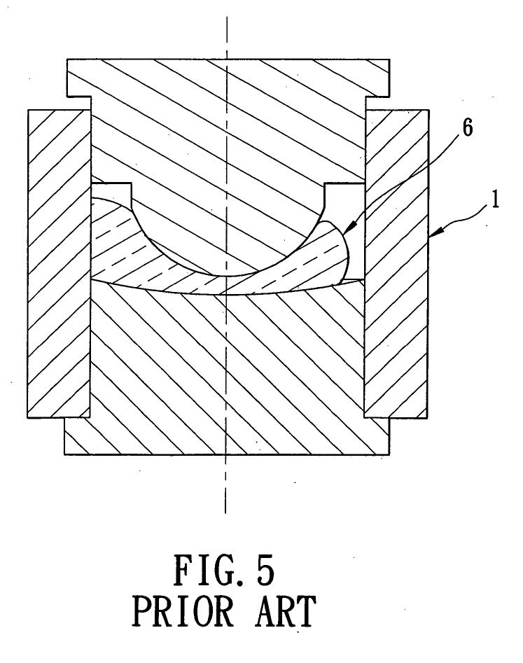

FIG. 6 is a sectional view of a first preferred embodiment of the present invention;

FIG. 7 is the same view as FIG. 6 but with a glass blank placed within a sleeve member;

FIG. 8 is the same view as FIG. 6 but with the sleeve member in abutment with upper and lower mold units;

FIG. 9 is the same view as FIG. 8 but with the glass blank being pressed by an upper molding core;

FIG. 10 is the same view as FIG. 9 but with the glass blank being formed into a lens;

FIG. 11 is a sectional view of the second preferred embodiment of the present invention;

FIG. 12 is a plan view of a sleeve member of the second preferred embodiment;

FIG. 13 is the same view as FIG. 11 but with the sleeve member in abutment with upper and lower mold units;

FIG. 14 is the same view as FIG. 11 but with glass blanks being formed into lenses; and

FIG. 15 is the same view as FIG. 12 but with the glass blanks being formed into lenses.

### DETAILED DESCRIPTION OF THE PREFERRED EMBODIMENTS

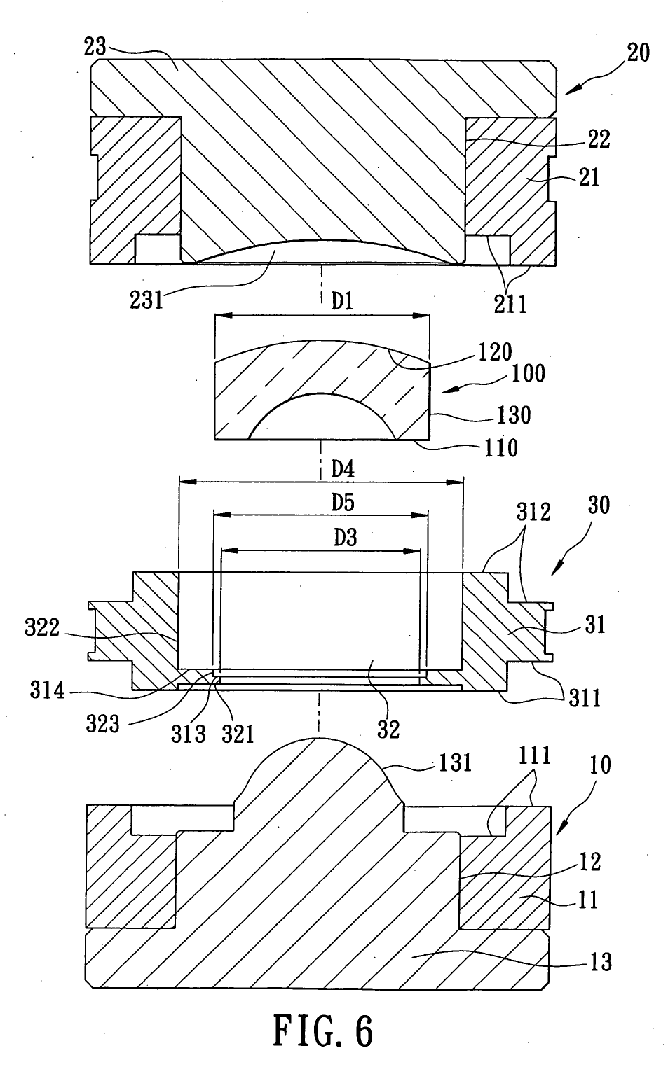

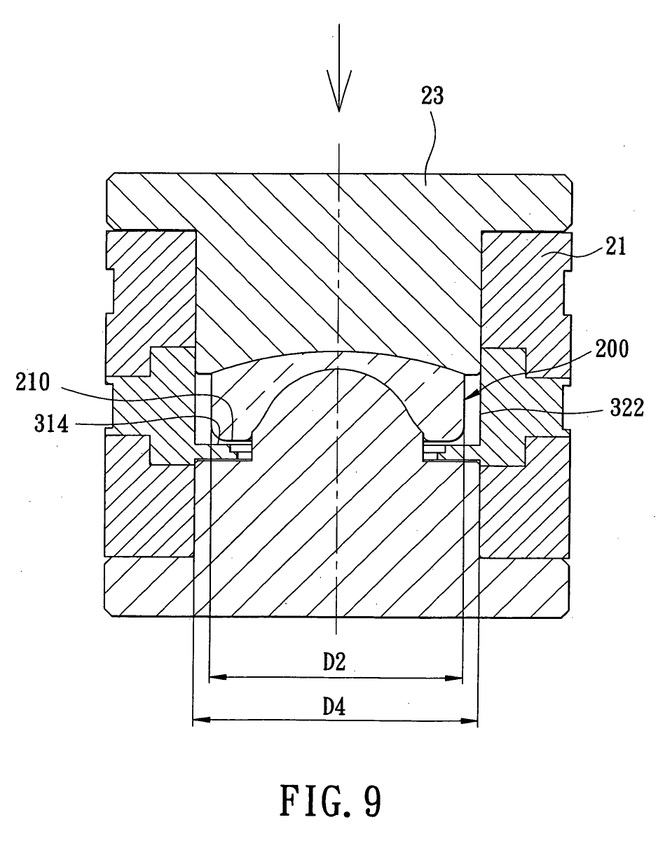

Before the present invention is described in greater detail, it should be noted that same reference numerals have been used to denote like elements throughout the specification. Referring to FIG. 6, there is shown a first preferred embodiment of the forming device according to the present invention which is adapted to form a glass blank 100 having with a small diameter (D1) into a lens 200 having a large diameter (D2) (see FIG. 9). The glass blank 100 has a bottom face 110, an opposite top face 120 and a peripheral bottom end 130 interconnecting the bottom and top faces 110, 120. The forming device includes a lower mold unit 10, an upper mold unit 20 and a sleeve member 30.

The lower mold unit 10 includes a lower socket member 11 defining a lower socket hole 12, and a lower molding core 13 inserted into the lower socket hole 12. The lower socket member 11 has a first abutment face 111, whereas the lower molding core 13 has a first forming face 131. In this embodiment, the first forming face 131 is provided ontop of the lower molding core 13, whereas the first abutment face 111 is formed on top of the lower socket member 11 around the first forming face 131.

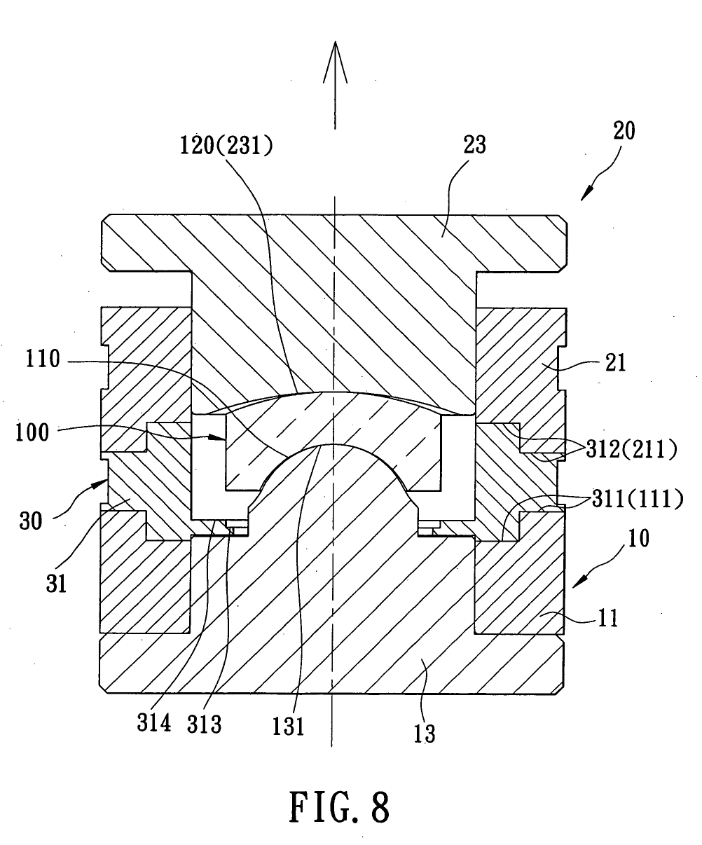

The upper mold unit 20 includes an upper socket member 21 defining an upper socket hole 22, and an upper molding core 23 inserted into the upper socket hole 22. The upper socket member 21 has a second abutment face 211, whereas the upper molding core 23 has a second forming face 231 facing the first forming face 131. In this embodiment, the second abutment face 211 is formed on the bottom end of the upper socket member 21 to face the lower molding core 13 and the second forming face 231 is formed on the bottom end of the upper molding core 23 to face the lower mold unit 10. The upper molding core 23 is movable relative to the upper socket member 21 to displace between a first position which is away from the lower molding core 13 (see FIG. 8) and a second position which is close to the lower molding core 13 (see FIG. 9).

The sleeve member 30 is mountable removably between the upper and lower mold units 20, 10, and includes a sleeve wall 31 defining a slot 32. The slot 32 has a first slot section 321 having a diameter (D3) smaller than an outer diameter (D1) of the glass blank 100, a second slot section 323 connected to the first slot sections 321 and having a diameter (D5) substantially equal to the diameter D1 of the glass blank 100, and a third slot section 322 which has a diameter (D4) larger than an outer diameter (D2) of the lens 200. The second slot section 323 interconnects the first and third slot sections 321, 322.

The sleeve wall 31 has a third abutment face 311 to abut against the first abutment face 111, a fourth abutment face 312 to abut against the second abutment face 211, a first support face or a first shoulder face 313 formed between the first and second slot sections 321, 323 to support the glass blank 100, and a second support face or second shoulder face 314 formed between the second and third slot sections 323, 322 to support the lens 200 (see FIG. 9). The third and fourth abutment faces 311, 312 are formed respectively at the bottom and top ends of the sleeve wall 31.

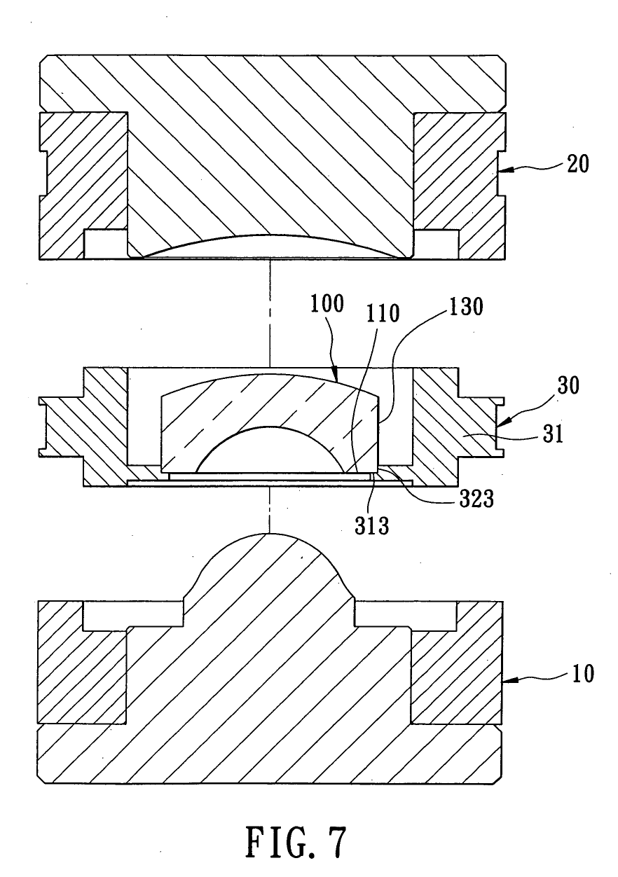

Referring to FIG. 7, when the forming device of the present invention is in use, the glass blank 100 is seated on the first shoulder face 313 of the sleeve wall 31 of the sleeve member 30 so that the peripheral bottom end 130 of the glass blank 100 is bounded by the wall of the second slot section 323, and the sleeve member 30, together with the glass blank 100, is disposed between the upper and mold units 20, 10 by using a robot arm (not shown) which carries the sleeve member 30.

Referring to FIG. 8, after the sleeve member 30 is mounted on the lower mold unit 10, the upper mold unit 20 is lowered and assembled with the sleeve member 30. At this state, the third and fourth abutment faces 311, 312 of the sleeve member 31 respectively abut against the first and second abutment faces 111 and 211 of the lower and upper socket members 11 and 21. Since, after assembly, the first forming face 131 of the lower molding core 13 is higher than the second shoulder face 314 of the sleeve wall 31, the glass blank 100 is lifted by the first forming face 131 from the first shoulder face 313 so that the top face 120 of the glass blank 100 pushes upward the upper molding core 23 to a first position as shown in FIG. 8. When the upper molding core 23 is moved downward from the first position to a second position as shown in FIG. 9, the glass blank 100 is pressed and formed into the lens 200. The peripheral bottom end of the lens 200 extends to a level above and near the second shoulder face 314.

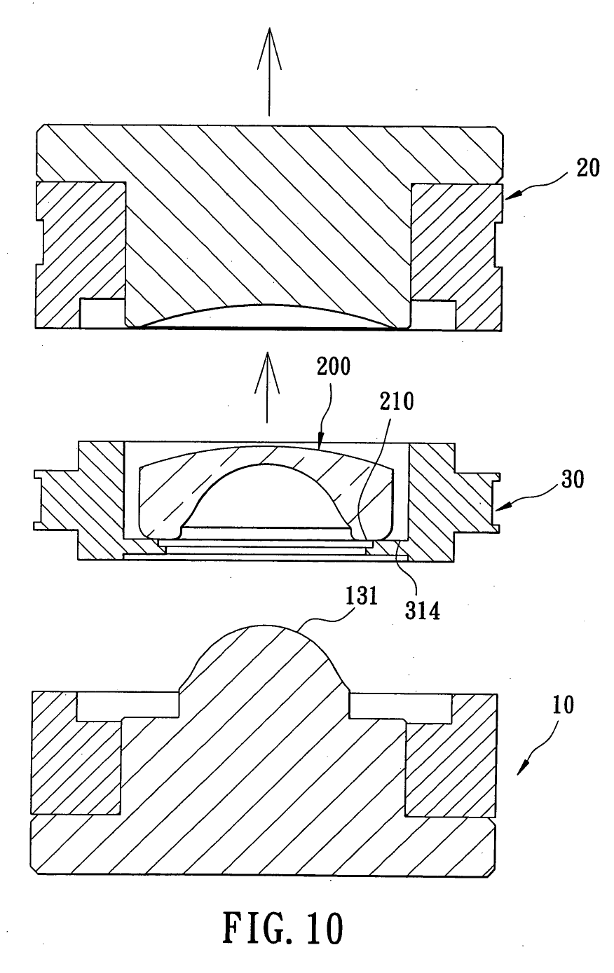

Referring to FIG. 10, the upper molding core 20 is moved upward to separate from the sleeve member 30, and the sleeve member 30 is moved upward to depart from the lower molding core 10. As the sleeve member 30 is moved upward from the lower molding core 10, the lens 200 is moved away from the first forming face 131 so that the peripheral bottom end 210 of the lens 200 is supported by the second shoulder face 314 of the sleeve wall 31. Therefore, the sleeve member 30 together with the lens 200 can be removed from the lower and upper mold units 10 and 20. As such, the lens 200 may be carried by the sleeve member 30 for transport to a next processing station.

The advantages of the present invention are as follows:

1. When the glass blank 110 is placed on the first shoulder face 313 of the sleeve member 30, the peripheral bottom end 130 of the glass blank 100 is bounded by the sleeve wall 31 in the second slot section 323 so that the glass blank 100 will not slip or run out of alignment with the center of the sleeve member 30. Therefore, when the sleeve member 30 and the glass blank 100 are assembled with the upper and lower mold units 20, 10, the glass blank 100 can be aligned automatically with the center of the upper and lower mold units 20, 10. As such, positional deviation of the glass blank 100 and formation of an asymmetric lens can be effectively prevented, thereby increasing the yield of good quality products.

2. Unlike the prior art, the forming device of the present invention does not require any suction nozzle to take out the lens 200 from the forming device after the lens 200 is formed. Since the lens 200 may be carried by the sleeve member 30 for transport between processing stations, the transporting procedure can be simplified and the production rate can be increased.

3. As shown in FIG. 10, unlike the forming face of the lower molding core 2 in the prior art, the first forming face 131 of the lower mold unit 10 protrudes upward so that a concavity is formed in the bottom face of the lens 200 and a peripheral bottom end 210 surrounds the concavity formed in the bottom face. After the sleeve member 30 is removed from the lower and upper mold units 10, 20, only the peripheral bottom end 210 of the lens 200 is supported by the sleeve member 30. As a major portion of the lens 200 does not contact the sleeve member 30, when the lens is subjected to cooling, the use of the sleeve member 30 as a support for the lens 200 can alleviate the problem of stresses resulting from the difference between thermal expansion coefficients of the lens 200 and its support.

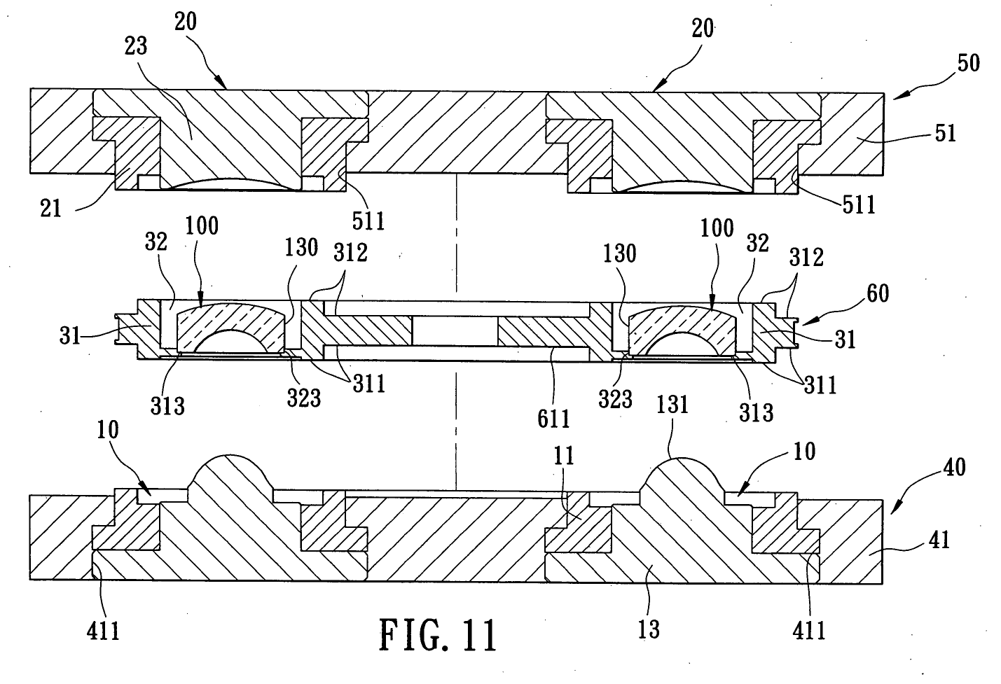

Referring to FIG. 11, there is shown a second preferred embodiment of the present invention which includes a lower mold assembly 40, an upper mold assembly 50 and a sleeve member 60.

The lower mold assembly 40 includes a lower support plate 41 having a plurality of spaced apart hollow parts 411. A plurality of lower mold units 10, specifically four mold units 10 (only two are shown), are fitted respectively in the hollow parts 411. The lower mold units 10 thus forms a unitary body.

The upper mold assembly 50 includes an upper support plate 51 having a plurality of spaced apart hollow parts 511. A plurality of upper mold units 20, specifically four mold units 20 (only two are shown), are fitted respectively in the hollow parts 511. The upper mold units 20 thus form a unitary body.

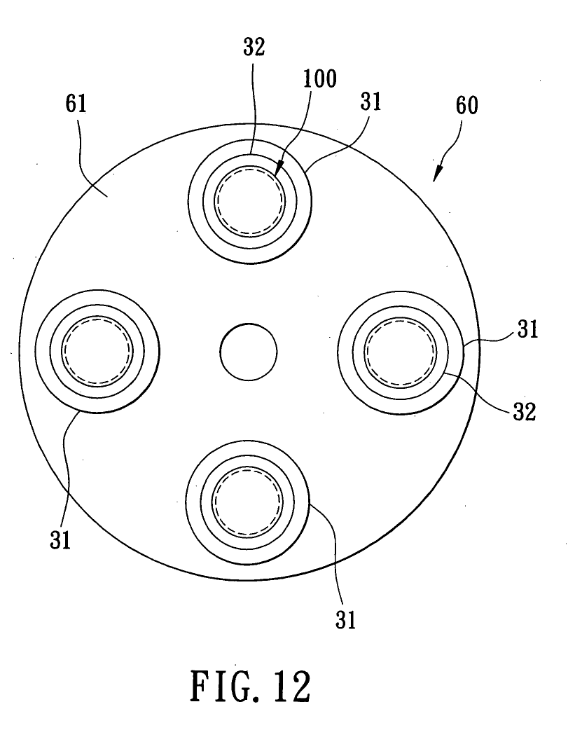

Referring to FIG. 12 in combination with FIG. 11, the sleeve member 60 includes a plurality of spaced apart sleeve walls 31, specifically four sleeve walls 31, and a connecting web 61 which is connected integrally with each sleeve wall 31. Each sleeve wall 31 is removably mountable between one of the lower mold units 10 and one of the upper mold units 20. Since the constructions and functions of the sleeve wall 31, and the upper and lower mold units 20, 10 have been described hereinbefore, they will not be detailed hereinafter.

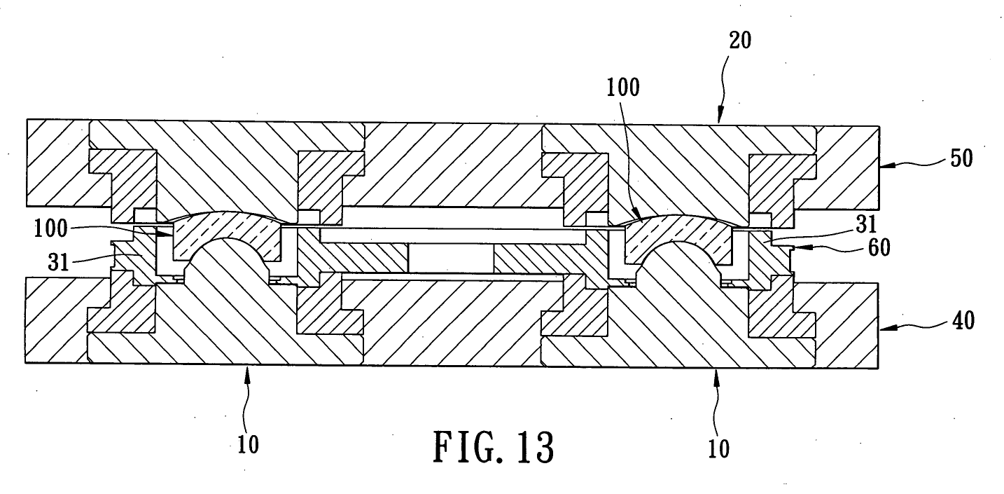

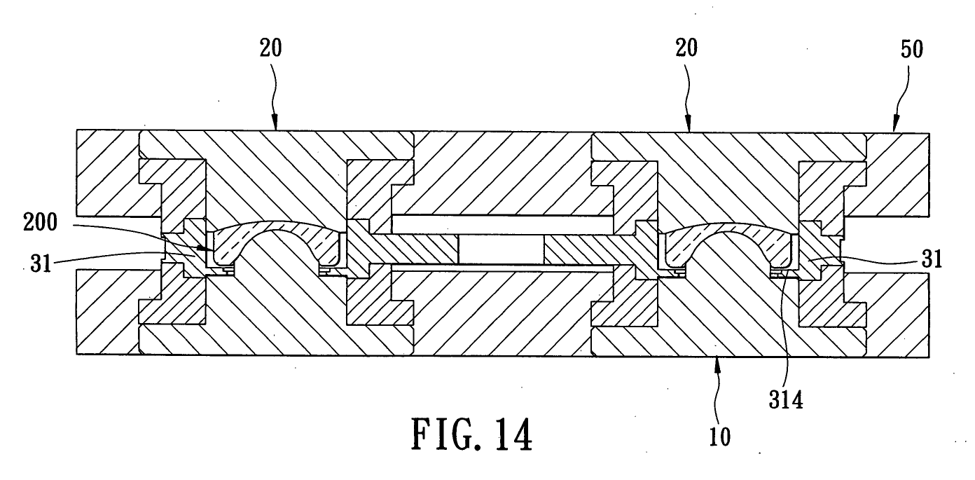

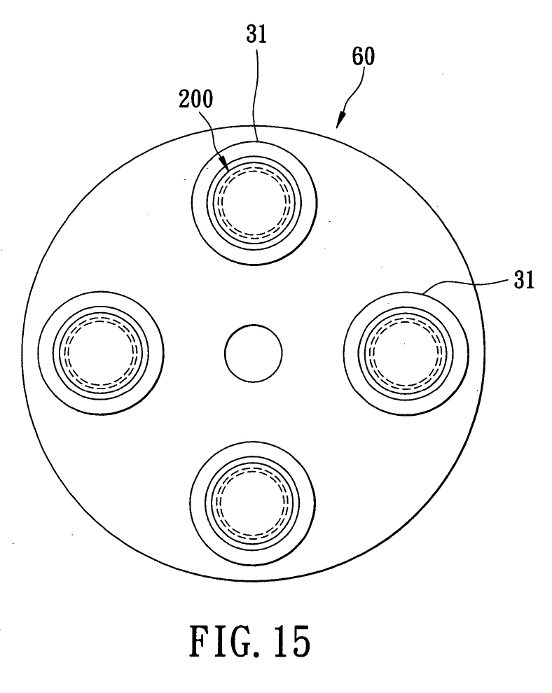

With the forming device of this embodiment, a plurality of sleeve walls 31 can be assembled with respective lower and upper mold units 10, 20 at one time, and a plurality of glass blanks 100 can be formed simultaneously within the respective sleeve walls 31, as shown in FIGS. 13-15.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

We claim:

1. A forming device for forming a glass blank into a lens, comprising:
at least one lower mold unit including a first forming face, and a first abutment face;
at least one upper mold unit including a second forming face to confront said first forming face, and a second abutment face;
a sleeve member mountable detachably between said lower and upper mold units, said sleeve member having at least one sleeve wall defining a slot, said slot including a first slot section with a diameter smaller than an outer diameter of the glass blank, and a second slot section connected to said first slot section and having a diameter substantially equal to the outer diameter of the glass blank, the sleeve wall including a third abutment face to abut against said first abutment face, a fourth abutment face to abut against said second abutment face, a first shoulder face formed between said first and second slot sections and adapted to support the glass blank, and a second shoulder face formed around said second slot section above said first shoulder face and adapted to support the lens,
wherein, when said sleeve member is assembled with said lower mold unit, said first abutment face abuts against said third abutment face, and said first forming face extends into said slot to a height higher than said second shoulder face.

2. The forming device as claimed in claim 1, wherein said slot further includes a third slot section having a diameter larger than an outer diameter of the lens, said second slot section interconnecting said first and third slot sections, said second shoulder face being formed between said second and third slot sections.

3. The forming device as claimed in claim 2, wherein said lower mold unit further includes a lower socket member and a lower molding core inserted into said lower socket member, said first forming face being formed on top of said lower molding core, said first abutment face being formed on top of said lower socket member.

4. The forming device as claimed in claim 3, wherein said upper mold unit further includes an upper socket member, and an upper molding core inserted into said upper socket member, said upper molding core being movable relative to said upper socket member to displace away from or toward said lower molding core.

5. The forming device as claimed in claim 4, wherein said second forming face is formed on a bottom end of said upper molding core, said second abutment face being formed on a bottom end of said upper socket member.

6. The forming device as claimed in claim 5, wherein said third and fourth abutment faces are formed respectively on bottom and top ends of said sleeve wall.

7. The forming device as claimed in claim 1, which comprises a plurality of said lower mold units and a plurality of said upper mold units and which further comprises a lower support plate and an upper support plate, wherein said lower mold units are spaced apart from each other and supported by said lower support plate to form a unitary body, said upper mold units being spaced apart from each other and supported by said upper support plate to form a unitary body.

8. The forming device as claimed in claim 7, wherein said lower support plate includes a plurality of spaced apart hollow parts to receive respectively said lower mold units, said upper support plate including a plurality of spaced apart hollow parts to receive respectively said upper mold units.

9. The forming device as claimed in claim 8, wherein said sleeve member includes a plurality of said sleeve walls which are spaced apart from each other, and a connecting web connected integrally with each of said sleeve walls, each of said sleeve walls being mountable between one of said lower mold units and one of said upper mold units.

10. A forming unit for forming a glass blank into a lens, each of the glass blank and the lens having a top face, and a bottom face which has a peripheral bottom end, the forming unit comprising:
a lower mold unit including a first forming face adapted to press the bottom face of the glass blank;
an upper mold unit including a second forming face adapted to press the top face of the glass blank; and
a sleeve member mountable between said lower and upper mold units and having a sleeve wall extending around said first and second forming faces,
wherein said sleeve wall has a support face provided around said first forming face and adapted to support solely the peripheral bottom end of the lens after the glass blank is formed into the lens.

11. The forming unit as claimed in claim 10, wherein said first forming face protrudes upward.

12. A forming unit for forming a glass blank into a lens, comprising:
a lower mold unit including a first forming face;
an upper mold unit including a second forming face; and a sleeve member mountable detachably between said lower and upper mold units and having-a sleeve wall extending around said first and second forming faces, said sleeve wall having a first support face adapted to support the glass blank, and a second support face adapted to support the lens.

13. The forming unit as claimed in claim 11, wherein each of said first and second support faces is disposed around said first forming face.
